(19) United States
(12) Patent Application Publication
(10) Pub. No.: US 2012/0044538 A1
(43) Pub. Date: Feb. 23, 2012

(54) SYSTEM AND METHOD FOR PRINTING VIA VIRTUAL MACHINES

(75) Inventors: I-Jong Lin, Palo Alto, CA (US); Paul F. Matheson, Palo Alto, CA (US)

(73) Assignee: HEWLETT-PACKARD DEVELOPMENT COMPANY, L.P., Fort Collins, CO (US)

(21) Appl. No.: 13/318,393

(22) PCT Filed: May 6, 2009
(86) PCT No.: PCT/US09/43017

§ 371 Date: Nov. 1, 2011

(30) Foreign Application Priority Data
May 6, 2009 (US) PCT/US2009/43017

(51) Int. Cl. G06F 3/12

(52) U.S. Cl. 358/1.15

(57) ABSTRACT

A system and method of printing via virtual machines is disclosed.

### BACKGROUND

The advent of computer-based or digital printing has made commercial printing services more widely available and affordable for many businesses and consumers. In addition, by moving away from traditional printing models, digital printing has brought more flexibility to how a printing job is structured and delivered. For example, one type of digital printing includes variable data printing in which each document or sets of documents are customized for each recipient or groups of recipients. Variable data printing is commonly used in mass marketing mail campaigns or other targeted communications. For example, with variable data printing, as a set of documents are being printed, certain elements of each document (such a name, address, message, images or graphics) are modified on a document-by-document basis. This flexibility insures that each printed document is tailored appropriately for the target audience.

One way of providing variable data printing includes a print service provider providing a variable data printing software program to a customer. Theoretically, with both the customer and the print service provider having the same software to produce a print job, there should be high correspondence between the print job submitted by the customer and what is actually produced by the print service provider. However, in practice deviations exist between the submitted print job and the produced documents. Some deviations are caused by differences between the versions of the software program held by the print service provider and the customer, as the proprietary software programs have to be consistently updated and synchronized between both the customer and print service provider. Some other deviations typically result from differences in the computing environment of the customer and the computing environment of the print service provider.

Unfortunately, despite the best efforts of customers and print service providers, deviations between a submitted print job and the produced documents still pose a significant challenge to the world of variable data printing.

### BRIEF DESCRIPTION OF THE DRAWINGS

FIG. 1 is a set of block diagrams schematically illustrating a printing services system, according to an embodiment of the present disclosure.

FIG. 2 is a block diagram schematically illustrating a user computer, according to an embodiment of the present disclosure.

FIG. 3 is a flow diagram of a method of communicating a print job via a virtual machine, according to an embodiment of the present disclosure.

FIG. 4 is a flow diagram of a method of communicating a print job, according to an embodiment of the present disclosure.

FIG. 5 is a flow diagram of a method of communicating a print job, according to an embodiment of the present disclosure.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of the present disclosure are directed to enhancing the ability of a print service provider to produce a print job in a way that exactly corresponds to the appearance of the print job as intended by a customer that originally created the print job. In particular, a virtual machine manager is made available at the user computer to allow the user to capture, into a virtual machine, the print job and the applicable executable resources used to create the print job. The copy of this virtual machine is communicated to a print service provider. Upon activation of the copy of the virtual machine, the print service provider becomes equipped to produce the print job within a computing environment that is an exact replication of pertinent aspects of the customer's computing environment.

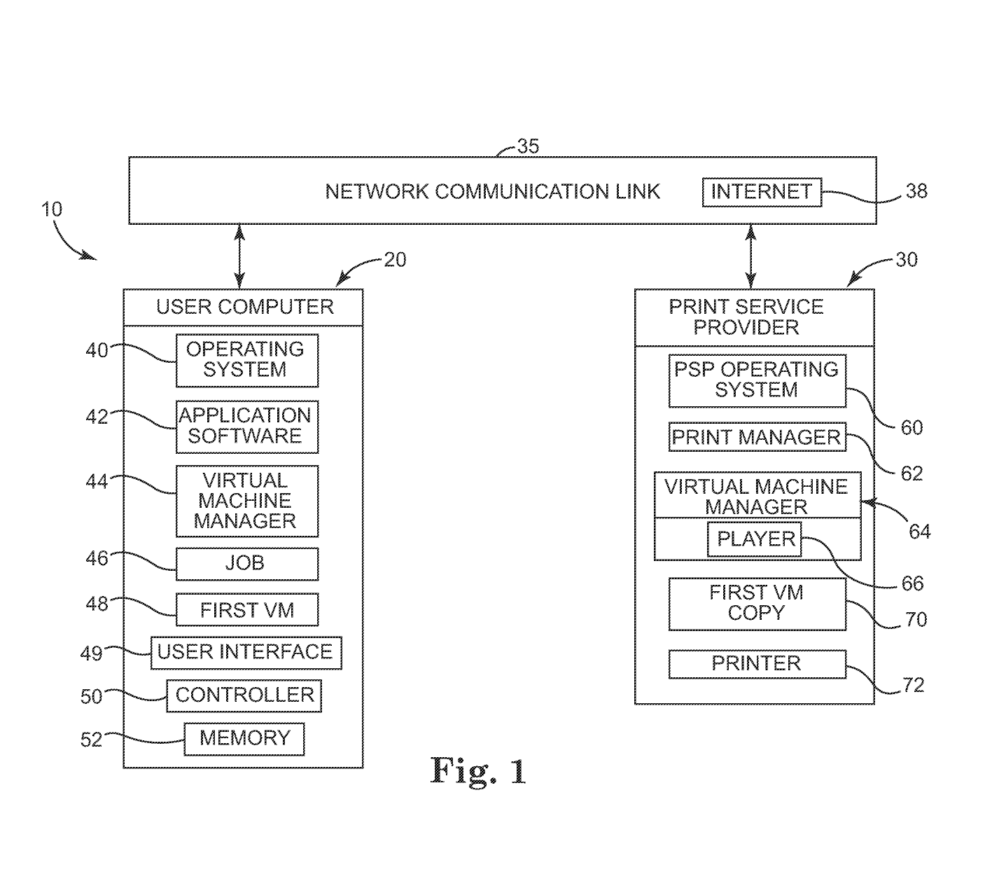

These embodiments, and additional embodiments, are described in association with FIGS. 1-5.

FIG. 1 schematically illustrates a printing services system 10, according to an embodiment of the present disclosure. As shown in FIG. 1, in one embodiment, system 10 comprises a user computer 20, a print service provider 30, and a network communication link 35. However, it is understood that system 10 is not limited to a single user computer 20 and is not limited to a single print service provider 30.

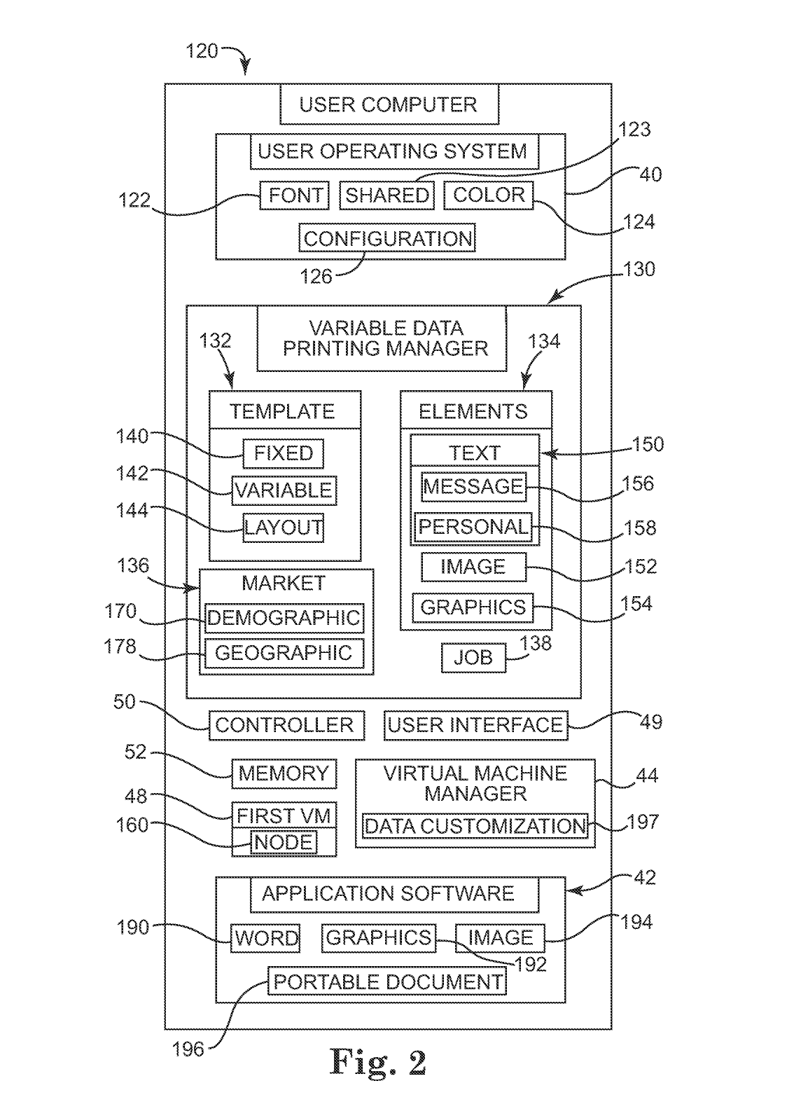

In general terms, among other features, user computer 20 is configured to create and edit print jobs suitable for submission to a print service provider 30, which is configured to professionally produce the print job. In one embodiment, as shown in FIG. 1, user computer 20 comprises an operating system 40, at least one application software module 42, a virtual machine manager 44, a print job 46, a first virtual machine (VM) 48, user interface 49, controller 50, and memory 52. These components of user computer 20 will be described generally with reference to FIG. 1 and then will be described in more detail in association with FIG. 2.

Accordingly, in general terms, operating system 40 is configured to provide for general operation of computer 20 and comprises an operating system such as a Linux® operating system, a Windows® operating system, or other known operating systems.

In general terms, application software module 42 is configured to provide a single application program or an array of application programs suitable to create and produce documents of a print job. In one aspect, the application software module 42 will provide for handling text, images, and/or graphics.

User interface 49, in general terms, provides access to and selection of the various modules, functions, parameters, resources, and components of the user computer 20. In one embodiment, user interface 49 comprises a graphical user interface.

Each of the operating system 40, application software module 42, and virtual machine manager 44 will be further described later in association with FIG. 2.

Together, the components of user computer 20 are used to produce a print job 46. As will be described in further detail in association with later FIGS. 2-5, in one embodiment the print job 46 comprises a variable data printing job. However, in other embodiments, print job 46 comprises other types of print jobs, such as a single document or a set of documents, which includes a fixed arrangement of text, images, and/or graphics.

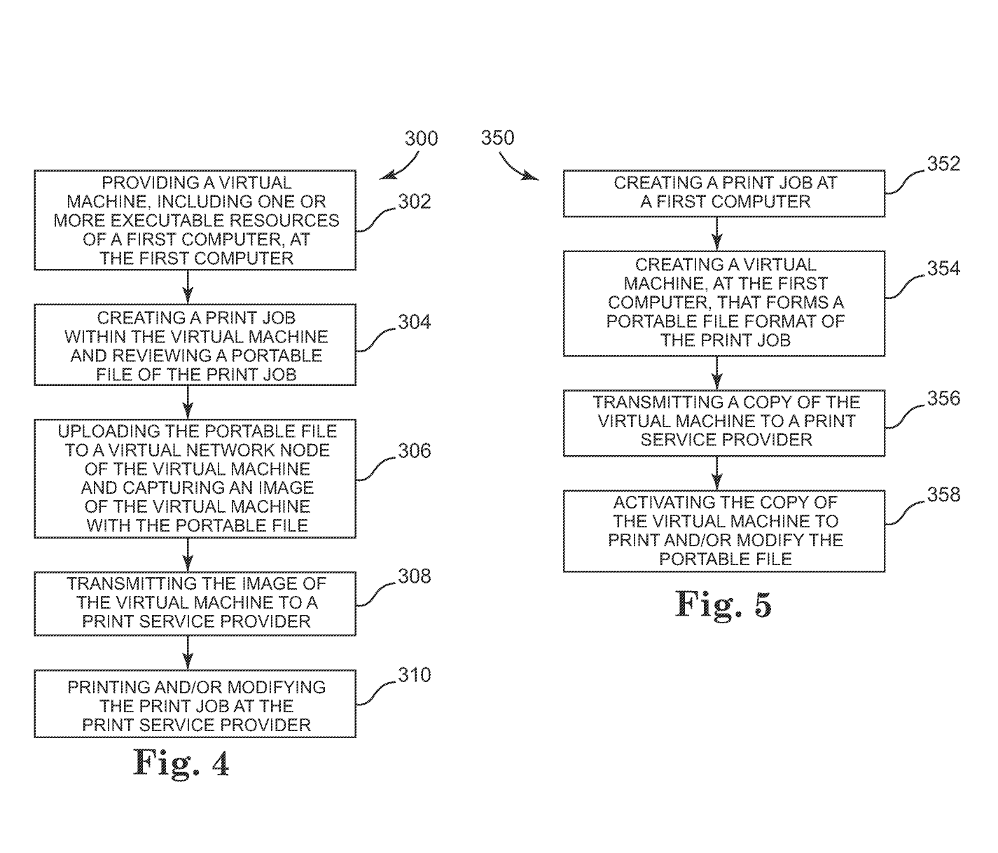

In one embodiment, user computer 20 also includes a virtual machine manager 44 capable of creating and/or playing a virtual machine at user computer 120. In one aspect, the virtual machine manager 44 creates a virtual machine 48 as an environment in which a software program, such as application software module 42 or a variable data printing manager (see, for example, manager 130 in FIG. 2), operates to create a print job. In another aspect, the virtual machine manager 44 creates a virtual machine 48 that captures or encapsulates one or more pertinent executable resources available at the user computer at the time the virtual machine is created. Both of these examples of operating virtual machine manager 44 will be further described later in association with FIG. 4 and FIG. 5, respectively.

In one non-limiting example, one type of a virtual machine manager 44 is available from VMware, Inc. of Palo Alto, Calif. However, virtual machine manager 44 is not strictly limited to the features of the virtual machine generator available from this vendor.

In one aspect, within the context of at least this present disclosure, it will be understood by one skilled in the art that a virtual machine is an isolated software container that uses its own operating system and own application programs. Although the virtual machine can reside as software on a first physical computer, this virtual machine behaves like an independently separate second physical computer and therefore, among other functions, the virtual machine has its own software-based central processing unit (CPU), memory, and interfacing systems.

In another aspect, once created, the virtual machine 48 is portable and can be transferred to another computing workstation, where the virtual machine 48 is activated to recreate the computing environment of the user computer at the “another” computing workstation. At the time the virtual machine 48 is created, one can selectively choose which executable components of the user's computing environment become encapsulated into the virtual machine 48. However, in one embodiment, the virtual machine 48 encapsulates an executable copy of an operating system and an executable copy of at least one application program configured to create, edit, and/or produce a print job.

Controller 50 comprises one or more processing units and associated memories configured to generate control signals directing the operation of user computer 20. In particular, in response to or based upon commands received via user interface 49 or instructions contained in the memory 52, controller 50 enables the operation of the various modules of user computer 20. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 50 may be embodied as part of one or more application-specific integrated circuits (ASICs). Unless otherwise specifically noted, the controller is not limited to any specific combination of hardware circuitry and software, nor limited to any particular source for the instructions executed by the processing unit.

Memory 52 generally supports operation of user computer 20 including its core functions, such as controller 50 and operating system 40, as well as the various modules and components of user computer 20.

In general terms, network communication link 35 is configured to provide an electronic communication pathway between a user computer 20 and print service provider 30. In one aspect, the network communication link 35 includes an internet communication link (e.g., the Internet), an intranet communication link, or another high speed communication link. The network communication link 35 may be a wired or wireless link. In one embodiment, network communication link 35 includes internet link 38.

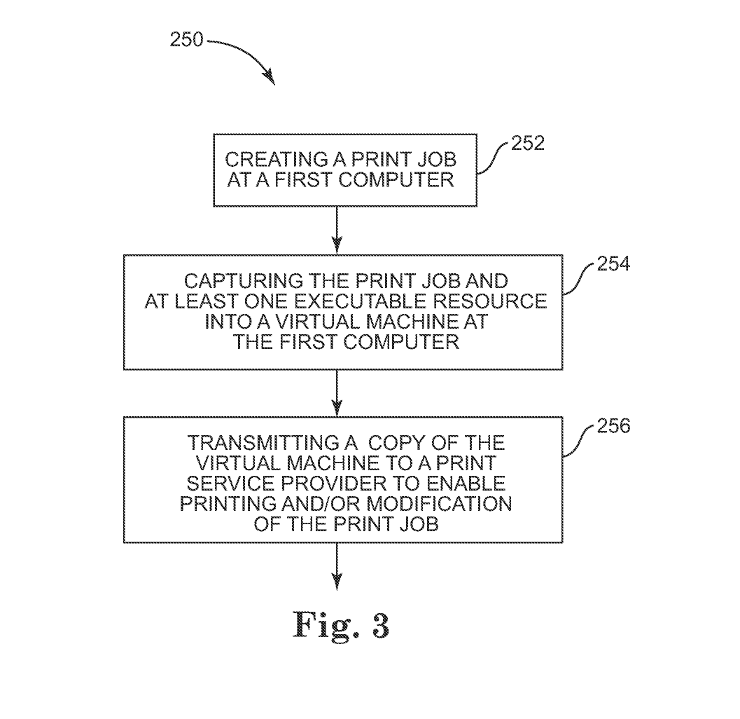

With further reference to system 10 of FIG. 1, in general terms, print service provider 30 is configured to receive print jobs from customers (such as a the user computer 20 of a customer) and then professionally produce the documents of the print job 46. As shown in FIG. 3, in one embodiment, print service provider 30 comprises an operating system 60, a print manager 62, a virtual machine manager 64, and a printer 72. In general terms, print manager 62 is used to manipulate and produce the print job 46 via printer 72 or a network of printers 72. In one embodiment, one or more printers 72 are located at a single geographic location while in other embodiments, printers 72 are located in several different geographic locations.

For each print job submitted by a customer, print service provider 30 also includes a first virtual machine copy 70. In one aspect, first virtual machine copy 70 contains a copy of print job 46 and a copy of one or more applicable executable resources from user computer 20.

The operating system 60 of print service provider 30 has at least substantially the same features and attributes as operating system 40 of user computer 20 while virtual machine manager 64 of print service provider 30 comprises at least substantially the same features and attributes as virtual machine manager 44 of user computer 20. In one aspect, like virtual machine manager 44, virtual machine manager 64 of print service provider 30 includes a player 66 configured to play a virtual machine or a copy of a virtual machine.

In one aspect, by using virtual machine manager 64 to activate first virtual machine copy 70 from user computer 20, the print service provider 30 gains access to print job 46 and to an exact replication of the computing environment used to create print job 46. Accordingly, within this computing environment, the print service provider 30 can reproduce and/or modify print job 46 is the same way that was intended by the customer. In one embodiment, in which the print job 46 comprises a variable data printing job, the first virtual machine copy 70 includes the variable data printing job with all the applicable executable resources from user computer 20 to print and/or modify that variable data printing job.

FIG. 2 is a block diagram of a user computer 120, according to an embodiment of the present disclosure. In one embodiment, user computer 120 comprises at least substantially the same features and attributes as computer 20 previously described in association with FIG. 1. As shown in FIG. 2, in one embodiment, user computer 120 comprises an operating system 40, a variable data printing manager 130, application software module 42, virtual machine manager 44, first virtual machine 48, controller 50, memory 52, and user interface 49. Via controller 50 and memory 52, operating system 40 supports operation of at least application software module 42, variable data printing manager 130, virtual machine manager 44, and user interface 49.

In addition to the features previously described in association with FIG. 1, in one embodiment operating system 40 includes at least one of a font resource 122, a shared device resource 123, a color resource 124, or a configuration settings resource 126. The font resource 122 is configured to provide a set of character fonts while color resource 124 is configured to provide a color table or other color resource that provides a color space viewable in user interface 49 or printable via a print driver of user computer 120. The shared device resource 123 is configured to track settings associated with shared devices accessed by the application software and/or operating system during creation, review, and modification of a print job. The configuration settings resource 126 provides basic configuration settings of operating system 40 that affect the results and operation of the various application software programs, such as those in application software module 42, variable data printing manager 130, etc.

In addition to the features previously described in association with FIG. 1, in one embodiment application software module 42 comprises a word processing program 190, a graphics handling program 192, an image handling program 194, and/or a portable document program 196. In some embodiments, these different programs are provided in a suite of programs or integrated into a single application package. It will be further understood that these programs will be accessible by variable data printing manager 130 in order to build a document or set of documents. In one embodiment, the portable document program 196 includes a portable document program of the type available from Adobe Systems Incorporated, such as Adobe Acrobat Reader or other more complex types of portable document format applications known to those skilled in the art.

With further reference to FIG. 2, user computer 120 includes a variable data printing manager 130. In general terms, variable data printing manager 130 enables a user to assemble and produce a set of documents includes some elements that have variable data that changes from document to document within a print job. In some embodiments, variable data printing manager comprises a suite or package of application tools, such as Adobe® InDesign® application tools available from Adobe Systems Incorporated of San Jose, Calif. In one example, the variable data printing manager comprises an application module, such as HP® SmartStream® Designer, which is available from Hewlett-Packard Company of Palo Alto, Calif., in a partnering arrangement with Abode Systems Incorporated. It will be understood that other commercially available application software tools can function as a variable data printing manager.

With this in mind, in one embodiment a variable data printing manager 130 of user computer 120 comprises a template module 132, an elements selection module 134, a target market module 136, and a job module 138.

Template module 132, in general terms, is configured to provide a document template through which a user is able to configure a document. The template module 132 comprises a fixed parameter 140, a variable parameter 142, and a layout parameter 144. The fixed parameter 140 is configured to freeze or maintain one or more elements of a document template from document to document while the variable parameter 142 is configured to identify which elements of a document template will be permitted to vary from document to document according to the variable data corresponding to that variable element. In one embodiment, the layout parameter 144 is configured to allow selection and/or modification of a layout from a number of predetermined layouts of text, images, and/or graphics while in other embodiments, the layout parameter 144 provides for creation of a layout or format of text, images, and/or graphics.

Elements selection module 134, in general terms, is configured to specify various text, image, and/or graphics elements that will appear in the documents. In cooperation with layout parameter 144 of template module 132, the elements selection module 134 specifies the precise location in a document at which a textual element will appear, at which an image will appear, and at which a graphics element will appear. Moreover, via cooperation of fixed parameter 140 and variable parameter 142 of template module 132, the user can select which elements (text, image, and/or graphics) will be fixed or variable in the layout of the document.

As shown in FIG. 2, in one embodiment, elements selection module 134 comprises a text module 150, an image module 152, and a graphics module 154. The text module 150 comprises a message parameter 156 and a personal information parameter 158. The message parameter 156 is configured to provide user control over which textual message is included in a document and can access memory 52 to retrieve one or more different messages (or portions of a message) for inclusion in a document. The personal information parameter 158 is configured to provide user control over which personal information is included in a document and accesses memory 52 to retrieve one or more types of personal information. This personal information includes, but is not limited to, salutation, name, address, interests, profession, etc.

The image module 152 and graphic module 154 are configured to provide control over selection and inclusion of one or more images and graphics (respectively) into one or more documents of a print job. In one aspect, the images and/or graphics are stored in memory 52.

It will be understood that layout function 144 of template module 132 will assist the user in selecting and/or properly adjusting the size and shape of the images, graphics, or text to fit together within the document.

The market module 136 is configured to adjust a document, a set of documents, or a variable data stream of documents relative to a demographic parameter 170 and/or a geographic parameter 178. For example, the demographic parameter 170 allows one set of text, images, and/or graphics to be included for a first demographic group (e.g., senior citizens) while a second set of text, images, and/or graphics are included for a second demographic group (e.g., single mothers). It will be understood that these adjustments for demographic factors can be made for just one element or for multiple elements within a document.

Similarly, the geographic parameter 178 allows one set of text, images, and/or graphics to be included for a first demographic group (e.g., west coast of United States) while a second set of text, images, and/or graphics are included for a second demographic group (e.g. Eastern Europe).

It will be understood that in some embodiments the use of the demographic parameter 170 and/or geographic parameter 178 will result in more or less than two sets of images, graphics, and/or images in order to target the different demographic groups and geographic regions of interest.

Once all the choices for a document are made via template module 132, elements module 134, and/or market module 136, then variable data printing manager 130 compiles or processes that information into a single print job 138 that can be executed to produce the document, set of documents, or stream of variable data documents.

In one embodiment, virtual machine manager 44 and variable data printing manager 130 are provided separately within user computer 120. However, in other embodiments, virtual machine manager 44 and variable data printing manager 130 are provided within the same suite of software applications or are provided in an integrated manner a single software package.

First virtual machine 48 represents a virtual machine, generated by virtual machine manager 44, and which encapsulates a print job 138 and applicable executable resources used to create the print job 138. In one embodiment, these applicable executable resources include an executable operating system file and at least one executable document application resource. In one aspect, the encapsulated operating system file includes at least font resources 122, color resources 124, shared device resources 123, and/or configuration settings resources 126.

In some embodiments, the virtual machine 48 includes a portion of an executable resource of the user computer 20, 120 when the entire executable resource is unnecessary to replicate a minimum computing environment at print service provider 30 to print and/or modify a print job. In other words, by capturing a smaller portion or version of an executable resource of the user computer 20, the virtual machine manager 44 effectively compresses the replicated computing environment of the user computer 20, 120.

In some embodiments, a first virtual machine 48 that is generated via virtual machine manager 44 includes a virtual network node 49. The node 49 is configured to enable communication by the first virtual machine 48 with other devices, such as user computer 120 and/or print service provider 30 (FIG. 1).

User interface 49 enables control over and selection of the various modules, functions, parameters, resources, and components of the user computer 120. Moreover, the modules, functions, parameters, resources, and components of variable data printing manager 130, application software module 42, virtual machine manager 44 illustrated in FIG. 2 represent actual functions supported by software, hardware, and/or firmware and represent displayable and selectable features of user interface 49.

In one embodiment, because the print service provider 30 will be using an exact replication of the user's computing environment (by virtue of the first virtual machine 48) to produce a submitted print job, the user interface 49 enables viewing the print job 38 at user computer 20,120 in a what-you-see-is-what-you-get manner. In other words, the customer can be confident that the print service provider 30 will be capable of seeing the job and producing the job in exactly the same way it was seen by the customer.

Accordingly, with the use of a virtual machine 48, a print job 138 and the computing environment used to produce that print job are communicated from a customer to a print service provider. Via activation of the virtual machine 48 at the print service provider 30, the print job 138 is printed and/or modified in exactly the same computing environment that the customer used. Conventionally, a computing environment of a print service provider causes small, but significant differences in documents of a print job relative to a computing environment of customer. However, with some embodiments of the present disclosure providing a replication of the operating system of customer's computer 20, 120 (which includes resources such as font resource 122, color resource 124, shared device resources 123, configuration settings resource 126), the print service provider 30 no longer faces the challenge of conventionally adjusting the print job or its computing environment in order to adjust or compensate for the computing environment of the customer.

In some embodiments, virtual machine manager 44 includes a data customization module 197, as shown in FIG. 2. In one aspect, data customization module 197 is configured to generate more than one virtual machine 48 in association with a print job to enable customizing various aspects of the print job while capitalizing on the use of virtual machines to communicate the print job. In one non-limiting example, the user computer 120 is used to create a black-and-white print job that becomes part of a “black-and-white” printing virtual machine and used to create a color print job that becomes part of a color printing virtual machine. Via data customization module 197, the virtual machine manager 44 further creates a third virtual machine that encapsulates at least the black-and-white virtual machine, the color virtual machine, and appropriate executable resources (e.g., operating system, applications, etc). The third virtual machine also encapsulates user interface 49 (or another user interface) such that upon activation of the third virtual machine by a print service provider, the third virtual machine is configured to enable selection by the print service provider of one of the black-and-white virtual machine or the color virtual machine. In this way, the print service provider need not manipulate the print job to obtain a black-and-white print job or color print job. It will be understood that other types of data customization of a print job may be performed via data customization module 197 of virtual machine manager 44. In other embodiments, data customization module 197 is located elsewhere within computer 120 but cooperable with virtual machine manager 44 to provide the above-described functions.

FIG. 3 is a flow diagram of a method 250 of communicating a print job, according to an embodiment of the present disclosure. In one embodiment, method 300 is performed using systems, components, and resources of a printing services system as previously described in association with FIGS. 1-2. In other embodiments, other systems and components are used to perform method 300.

In one embodiment, as shown in FIG. 3, at 252 method 250 includes creating a print job at a first computer. In one aspect, the print job is created using proprietary variable data printing software supplied by or compatible with the software of a print service provider. Alternatively, the print job is created using other application software available at the first computer.

At 254, the print job and at least one executable resource of the first computer are captured into a virtual machine at the first computer. In one example, the first computer includes an executable code for its operating system and executable code for is application software used to create the print job. Accordingly, the actual print job and each executable software resource (such as the operating system, a word processing program, an image handling program, a graphics handling program, or combinations thereof) are captured into the virtual machine to effectively capture the computing environment at the first computer that produced the print job. In one aspect, in capturing or encapsulating these executable resources, the virtual machine captures font resources, color resources, shared device resources, and/or configuration settings that give rise to unique aspects of the customer's computing environment, such as file dependencies unique to the print job. In this way, the computing environment becomes portable and can be transferred or communicated to other entities, such as a print service provider.

At 256, a copy of the virtual machine is transmitted or otherwise communicated to the print service provider to enable printing and/or modification of the print job. Once the print service provider is in possession of the copy of the virtual machine and activates that copy of the virtual machine, the print service provider is free to operate in exactly the same computing environment as the user. This replication of the user's computing environment ensures that the print service provider will be able to faithfully or exactly reproduce the print job in way that was perceived by the user. Moreover, in this replicated computing environment, the print service provider is able to modify the print job using the tools of the user's computing environment.

The general principles of the present disclosure include using a virtual machine to capture and transfer a print job (along with the supporting executable resources). However, there is more than one way to accomplish this transfer. Accordingly, FIGS. 4 and 5 schematically illustrate different methods to implement this transfer of the print job via a virtual machine. In association with FIG. 4, method 300 creates or provides a virtual machine before creation of the print job and the virtual machine is used to create the print job. However, in association with FIG. 5, method 300 creates the print job and then later creates a virtual machine that captures the print job and applicable executable resources.

With this comparison in mind, FIG. 4 is flow diagram schematically illustrating a method 300 of communicating a print job via a virtual machine, according to an embodiment of the present disclosure. As shown in FIG. 4, at 302 method 300 includes providing a virtual machine a first computer with the virtual machine including one or more executable resources. In one non-limiting example, the virtual machine includes an executable operating system and an executable variable data printing program. In another example, instead of the executable variable data printing program, the virtual machine includes separate application programs (e.g., word processing, image handling, and/or graphics handling) used to create the print job.

At 304, the print job is created and reviewed using the applicable executable resources of the virtual machine. In one example, the print job is reviewed in the form of a portable document format (e.g., PDF) or stream of portable documents to view the form that the series of documents will take upon printing.

At 306, in its portable document format (or other suitable format), the print job is uploaded to a virtual network node of the virtual machine and an image or copy of the virtual machine is captured and made available at the virtual network node.

At 308, the print job and the copy of the virtual machine are transmitted, via the virtual network node, to the print service provider. As shown at 310, the print service provider prints the print job and, if desired, modifies the print job via the virtual machine to achieve a final product that meets the objectives of the customer. As previously mentioned, because the executable resources within the virtual machine exactly replicate the customer's computing environment, the print service provider has the appropriate tools to modify the print job in the same manner that would have been otherwise performed by the customer in their own computer. Alternatively, the user can modify the print job themselves at their computer (e.g., the first computer) and then resubmit the modified print job via a virtual machine.

FIG. 5 is a flow diagram of a method 350 of communicating a print job, according to an embodiment of the present disclosure. As shown in FIG. 5, at 352 method 350 comprises creating a print job at a first computer. Once the print job is created, method 350 includes creating a virtual machine at the first computer and uses the virtual machine to generate a portable document format of the print job. After reviewing the portable document format of the print job, the user can go back and modify the print job or can approve the print job “as is”. Once approved, at 356 the user transmits, to a print service provider, a copy of the virtual machine that includes the print job (in the portable document format) and the executable resources of the first computer used to create the print job. At the 358, the print service provider activates the copy of the virtual machine to print the print job and/or to modify the print job. Ordinarily the print job would not be modified by the print service provider unless the customer provides feedback requesting correction or modification of some aspect of the print job. However, if the customer does make such a request, the presence of the copy of the customer's virtual machine at the print service provider enables the print service provider to make appropriate changes using the same computing environment that the user used to initially create the print job.

It will be further understood that, in some embodiments, either method 300 (FIG. 4) or method 350 (FIG. 5) can be modified so long as the resulting virtual machine communicated to the print service provider still achieves a faithful, accurate replication of the user's computing environment to enable production of the print job at the print service provider exactly as intended by the customer.

For example, in some embodiments, method 350 is modified to take advantage of already existing proprietary software. In particular, in this arrangement, the variable data printing manager 130 comprises a proprietary software module provided by a third party (such as a print service provider or other company) to produce a print job in the proprietary file format that would be submitted to a print service provider that has a reciprocating proprietary software module matching the user's proprietary software module. However, in this embodiment, instead of transmitting the print job in the proprietary file format, the proprietary software module at the user's computer includes a virtual machine manager or is cooperable with a virtual machine manager of the user's computer. In practical terms, this arrangement is achieved via adding a virtual machine driver to the proprietary software module via an upgrade or update to the proprietary software module. With this arrangement, upon activating the virtual machine selection within the proprietary software module at the user computer, the print job becomes encapsulated into a virtual machine. This virtual machine will include the print job and at least a copy of the executable operating system resource and of the executable proprietary software resource. The user will then transmit this virtual machine (or a copy thereof) to the print service provider, who can then activate the virtual machine to perform (or edit) the print job. The activated virtual machine at the print service provider provides an exact replication of the user's computing environment including the exact version of the proprietary software module. In this way, the user and the print service provider can still use the proprietary software module but without facing the challenge of continually managing the synchronization of the proprietary software modules at the respective locations of the user and the print service provider.

Embodiments of the present disclosure deliver on the promise of what-you-see-is-what-you-get printing in a relationship between a customer and a print service provider. The embodiments overcome discrepancies or deviations between a submitted print job and the produced print job by using a virtual machine to replicate the user's computing environment at the print service provider, thereby enabling accurate production of the print job as intended by the customer.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A computer implemented method of printing, the method comprising:
receiving, at a print service provider, a copy of a virtual machine from a first computer;
activating the copy at the print service provider to gain access to at least one executable resource of the first computer and to a print job that was created at the first computer; and
producing the print job, via the virtual machine, at the print service provider.

2. The method of claim 1 wherein producing the print job comprises producing the print job, from the copy, as a template and at least one variable element including at least one of a variable text component, a variable image component, or a variable graphics component.

4. The method of claim 1, further comprising:
providing the virtual machine at the first computer and then creating the print job at the first computer within the virtual machine.

5. The method of claim 4, wherein receiving the copy comprises:
receiving the copy from a virtual network node within the virtual machine of the first computer.

6. The method of claim 1, further comprising:
creating documents of the print job and then creating the virtual machine; and
generating, via the virtual machine, at least one portable document file from the print job.

7. The method of claim 1, wherein the at least one executable resource comprises at least one of:
at least one executable operating system file; and
at least one executable application software file that comprises at least one of:
a word processing program;
an image handling program;
a graphics handling program; or
a portable document program.

8. The method of claim 7, wherein the at least one executable operating system file comprises at least one of:
a font resource;
a color table resource;
a shared devices resource; or
a configuration settings resource.

9. A first computer comprising:
at least one executable application software resource configured to produce a print job;
at least one executable operating system resource;
a virtual machine producer configured to generate a virtual machine that encapsulates the print job, the at least one executable application software resource, and the at least one executable operating system resource from the first computer; and
a communication module configured to send a copy of the virtual machine to a print service provider.

10. The first computer of claim 9 wherein the virtual machine is configured so that operation of the copy by the print service provider causes printing of the print job.

11. The first computer of claim 9 wherein the virtual machine producer of the first computer is configured to generate a virtual network node cooperable with the communication module and configured to send the copy of the virtual machine to the print service provider.

12. The first computer of claim 9, wherein the at least one executable application software comprises a variable data printing program and the virtual machine producer is a component of the variable data printing program.

13. The first computer of claim 9, wherein the virtual machine producer includes a data customization module configured to produce a plurality of virtual machines associated with the print job with each respective virtual machine corresponding to a data variation of the print job, and wherein the data customization module is configured to also produce a respective one of the virtual machines as an user interface to enable selection, by a print service provider, for activation of one or more of the remaining respective virtual machines.

14. A document service provider comprising:
a computer including:
a virtual machine manager configured to activate a virtual machine copy that encapsulates a print job from a customer computer, wherein the virtual machine copy is configured to produce the print job and includes at least one executable application software resource and the at least one executable operating system resource from the customer computer; and
a communication module configured to receive the virtual machine copy from the customer computer; and
a printer in communication with the virtual machine manager and configured to print the print job.

15. The document service provider of claim 14, wherein the at least one executable application software resource within the virtual machine copy does not match other executable application software resources of the computer of the document service provider.
